(19) United States
(12) Patent Application Publication
(10) Pub. No.: US 2026/0329821 A1
(43) Pub. Date: Oct. 22, 2026

(54) DUPLICATE CHECKING AND MERGING OF DATA RECORDS

(71) Applicant: SAP SE, Walldorf (DE)

(72) Inventors: Ranjith PR, Wayanad (IN); Naveen Raj Kolanjiappan, Ariyalur (IN); Shweta Sureshchandra Gupta, Bangalore (IN); Edwin M. Jose, Kottayam (IN)

(73) Assignee: SAP SE, Walldorf (DE)

(21) Appl. No.: 19/186,431

(22) Filed: Apr. 22, 2025

(51) Int. Cl. G06F 16/215; G06F 16/22

(52) U.S. Cl. CPC G06F 16/215; G06F 16/2237

(57) ABSTRACT

Systems and processes for providing a service to check for duplicates in data records and perform merges of duplicate data records in a database are provided. In a method for performing duplicate checks and merges of data, user input may be received corresponding to a new data record. The user input may be converted into one or more vectors using word embeddings, and the vectors may be compared to stored vectors for existing data records in a database using one or more functions configured to indicate a likelihood of a match between the newly-entered data and one or more of the existing data records. Data for the new data record may be merged with an identified duplicate data record using a language model.

### BACKGROUND

Data record management may include systematic organization, storage, and retrieval of data to ensure its accuracy, consistency, and accessibility. Data structures, such as tables and fields, may be defined to store information pertaining to data records in a structured manner, for example in one or more databases. Effective data record management ensures that data in the databases is reliable, up-to-date, and readily available for decision-making and analysis.

Some database management systems utilize cloud-based platforms or services and are configured to store large amounts of data. However, as the amount of data increases, complexity and resource consumption of data management processes correspondingly increase as well. Accordingly, there remains a need for improved technologies to efficiently and accurately detect and manage duplicates in data records.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In summary, the detailed description is directed to various innovative technologies for identifying duplicate data records and merging duplicate data records in a database. In some examples, the disclosed technologies can be implemented as a method performed by a computer. The method may include receiving user input including newly-entered data for a new data record, converting the newly-entered data into one or more vectors using word embeddings, comparing the converted vectors to stored vectors for one or more existing data records in a database using one or more functions configured to indicate a likelihood of a match between the newly-entered data and one or more of the existing data records, and identifying a duplicate data record in the database, wherein the indicated likelihood of a match between the newly-entered data and the duplicate data record is above a threshold. The method may further include inputting the newly-entered data and the duplicate data record into a language model to determine relationships between the newly-entered data and fields of the duplicate data record, generating a merged data record by merging the newly-entered data with the duplicate data record based on the determined relationships between the newly-entered data and fields of the duplicate data record, and storing the merged data record in the database.

In some examples, the disclosed technologies can be implemented in a computing system including at least one hardware processor, at least one memory coupled to the at least one hardware processor, a database comprising a plurality of existing data records, and one or more non-transitory computer-readable media having stored therein computer-executable instructions that, when executed by the computing system, cause the computing system to receive newly-entered data for a new data record from an application user interface, convert the newly-entered data into one or more vectors using word embeddings, compare the converted vectors to stored vectors for the plurality of existing data records in the database using one or more functions configured to indicate a likelihood of a match between the newly-entered data and respective data records of the plurality of existing data records, and identify, among the plurality of existing data records, a duplicate data record, wherein the indicated likelihood of a match between the newly-entered data and the duplicate data record is above a threshold. The instructions may also cause the computing system to input the newly-entered data and the duplicate data record into a language model to determine relationships between the newly-entered data and fields of the duplicate data record, generate a merged data record by merging the newly-entered data with the duplicate data record based on the determined relationships between the newly-entered data and fields of the duplicate data record, and store the merged data record in the database.

In some examples, the disclosed technologies can be implemented as computer-readable media storing instructions which, when executed by one or more hardware processors, cause the hardware processors to perform the following actions. Newly-entered data for a new data record may be received from an application user interface. The newly-entered data may be converted into one or more vectors using word embeddings. The converted vectors may be compared to stored vectors for the plurality of existing data records in the database using one or more functions configured to indicate a likelihood of a match between the newly-entered data and respective data records of the plurality of existing data records. Among the plurality of existing data records, a duplicate data record may be identified, wherein the indicated likelihood of a match between the newly-entered data and the duplicate data record is above a threshold. The newly-entered data and the duplicate data record may be input into a language model to determine relationships between the newly-entered data and fields of the duplicate data record. A merged data record may be generated by merging the newly-entered data with the duplicate data record based on the determined relationships between the newly-entered data and fields of the duplicate data record. The merged data record may be stored in the database.

The foregoing and other objects, features, and advantages of the invention will become more apparent from the following detailed description, which proceeds with reference to the accompanying figures.

### BRIEF DESCRIPTION OF THE DRAWINGS

FIG. 1 is a block diagram of an example system for performing duplicate checks and merges in database systems in accordance with examples of the present disclosure.

FIG. 2 is a flow chart for performing duplicate checks and merges in database systems in accordance with examples of the present disclosure.

FIG. 3 shows example user interfaces for entering new data into a database and performing a duplicate check in accordance with examples of the present disclosure.

FIG. 4 shows example user interfaces depicting a result of merging new data into an existing data record based on a duplicate check performed in accordance with examples of the present disclosure.

FIG. 5 is a communication diagram showing example communications and operations for performing duplicate checks and merges in database systems in accordance with examples of the present disclosure.

FIG. 6 is a diagram schematically depicting a computing environment suitable for implementation of disclosed technologies.

FIG. 7 is a diagram schematically depicting computing devices operating in conjunction with a computing cloud for implementation of disclosed technologies.

### DETAILED DESCRIPTION

### Introduction and Overview

As described above, computing operations for managing large amounts of data in databases may be computing resource-intensive, and, in turn, cause runtime issues, delays, or even failures when executed. As one illustrative example, when dealing with complex data models and executing searches with multiple parameters and complex search criteria, runtime engines for managing databases may form multiple joins between physical tables. Additionally, operations to filter data (e.g., utilizing a WHERE clause, etc.) may need to be resolved in multiple steps to derive a final result list. For example, as per customer and application requirements, multiple queries may be run for a classification search, especially when dealing with a large number of characteristics (e.g., n>30, where n is the number of characteristics). This can result in the system operating close to a memory limit, causing slow statement processing and frequent timeouts, and sometimes even resulting in the process being unexpectedly ended prior to completion.

This disclosure describes a new approach of utilizing embeddings to detect duplicates in data records, which eliminates the need for joins and complex view stacks, making the resulting system more efficient and reducing or eliminating the above-described performance and runtime issues. The disclosed technologies enable database management systems to perform duplicate checks and merges as data is entered into the system in a scalable manner that improves system operation, even as the amount of data being managed in the databases increases.

Furthermore, some duplicate check approaches employ an extended setup to support out-of-the-box functionalities such as enabling ruleset execution, stopwords, and mapping tables. However, this setup becomes cumbersome as every execution needs to check these additional setups, especially for stopwords and mapping table-related configurations. Additionally, there may be cases where specific mapping data, such as abbreviations like “Corp” for “Corporation” or “Ltd” for “Limited,” are used, but the dictionary cannot accommodate all possible entries in the mapping table. This creates a challenge in managing and updating the mapping table. With the use of the disclosed technologies utilizing embeddings, these additional setups and challenges can be eliminated. Embeddings provide semantic rich context from the outside world and understand the general meaning of terms like “Corp” and “Ltd,” allowing them to be placed closer to their corresponding expansions like “Corporation” and “Limited” without requiring explicit mapping configurations.

### Example System

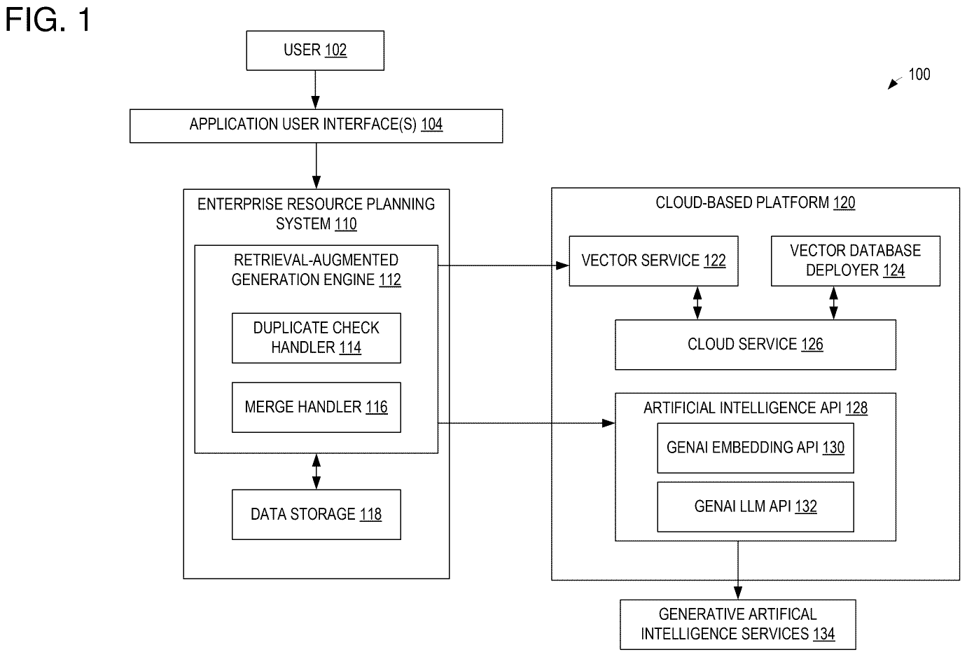

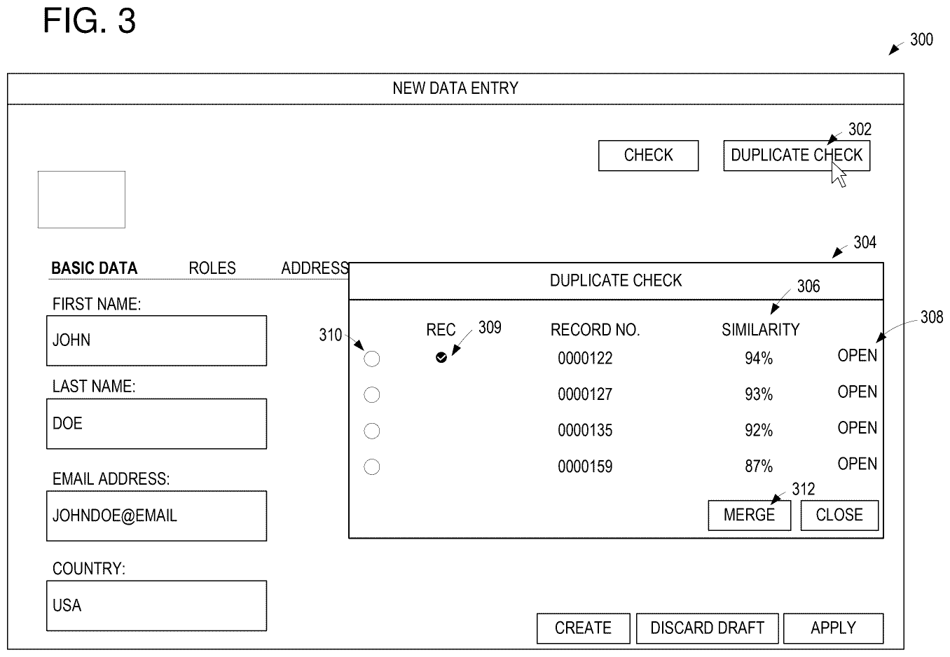

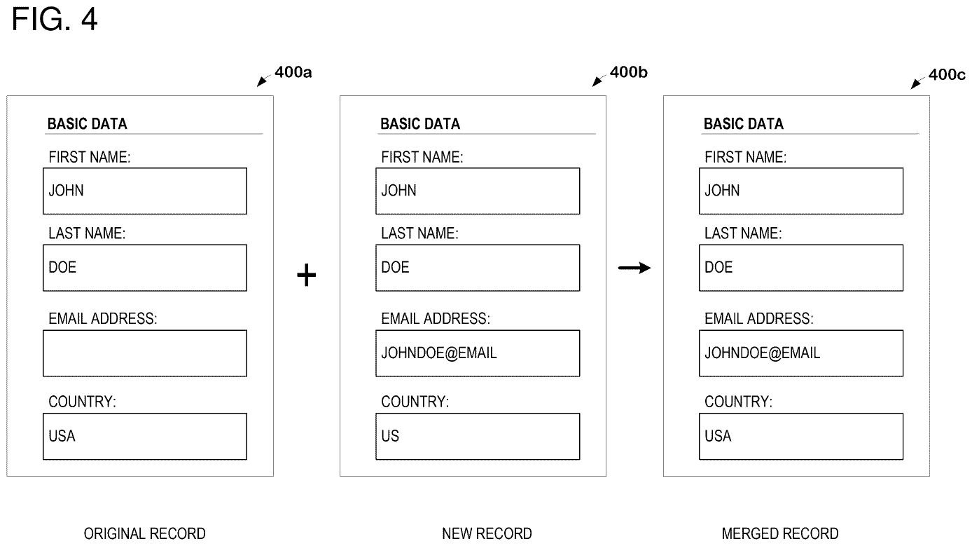

FIG. 1 shows an example block diagram of a system 100 for performing computing operations to manage data in a database, including performing duplicate checks and merging for newly-entered data, in accordance with examples of the present disclosure. In some examples, a user 102 may access an application user interface 104, which enables the user to interact with other systems, such as an enterprise resource planning system 110 that stores and/or accesses one or more databases or other data storage constructs. Examples of the application user interface 104, including examples relating to graphical user interfaces for interacting with the enterprise resource planning system and performing database updating and management, are described in more detail below with respect to FIGS. 3 and 4.

The enterprise resource planning system may include one or more computing systems comprising a processor(s) and memory storing instructions executable to perform operations of a retrieval-augmented generation engine 112, which comprises duplicate check handler 114 and merge handler 116. The retrieval-augmented generation engine 112 may be configured to coordinate requests for duplicate checks (e.g., via duplicate check handler 114) and merges of data (e.g., via merge handler 116) entered into application user interface(s) 104 for storage (e.g., as data records) in data storage 118. For example, data storage 118 may include one or more data bases storing data (e.g., data records) in one or more data structures. Although shown as being included in enterprise resource planning system 110, it is to be understood that one or more data storage devices holding the data in data storage 118 may additionally or alternatively remotely located and communicatively connected to enterprise resource planning system 110 and/or associated computing systems.

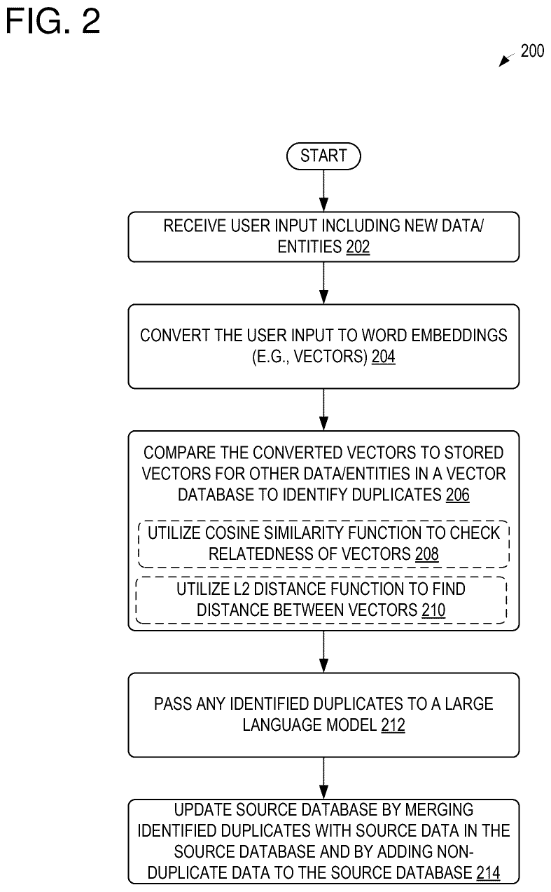

The data in data storage 118 may comprise existing data (e.g., existing data records) associated with the enterprise resource planning system, which may be updated by merging newly-entered data (e.g., entered via the application user interface(s) 104 with the existing data and/or by adding newly-entered data as new data (e.g., new data records). When entering new data, a duplicate check may be performed using duplicate check handler 114 to determine if the newly-entered data corresponds to an existing data record in the data storage 118. In order to perform the duplicate check, the duplicate check handler 114 may receive a request for performing the duplicate check (e.g., from the application user interface(s) 104) and, in response, prepare the newly-entered data for duplicate checking by coordinating a conversion of the newly-entered data into vectors using generative artificial intelligence (AI) services 134. For example, as described above, the disclosed technologies use word embeddings to convert newly-entered data into vectors that are able to be compared to vectors representing the existing data in data storage 118 to determine a likelihood that the newly-entered data corresponds to an existing data record in the data storage 118. The duplicate check handler 114 may provide the newly-entered data to a cloud-based platform 120, which includes an AI Application Programming Interface (API) 128 configured to interface (e.g., communicate and coordinate operation calls) with the one or more generative AI services 134. For example, the AI API 128 may include a generative AI (GenAI) embedding API 130 configured to engage one or more generative AI services 134 to convert data into vectors using word embeddings, which allows for the assignment of a quantitative value to data that accounts for context of the data. Examples relating to embeddings, vectors, and associated processes are described in more detail below with respect to FIG. 2.

The GenAI embedding API 130 may also be used during an onboarding process to convert existing data in the data storage 118 to vectors using embeddings, for use in comparison during duplicate checks. For example, the cloud-based platform 120 may include a vector database deployer 124 in communication with a cloud service 126 configured to instantiate and maintain a database of vectors corresponding to the data in data storage 118. The database of vectors may be stored in the cloud-based platform 120, within data storage 118, and/or in any suitable location accessible by the cloud-based platform 120. The cloud-based platform 120 may further include a vector service 122 configured to receive the vectors for newly-entered data, as determined using the generative AI services 134, and utilize functions executable by the cloud service 126 to determine similarity and/or distance of the vectors to vectors corresponding to the existing data (e.g., vectors stored in the vector database deployed by vector database deployer 124). For example, functions such as cosine similarity, to check a relatedness of vectors, and L2 distance, to find a distance between (and/or a closeness of) vectors, may be executed by the cloud service 126 to perform a duplicate check.

Results of the duplicate check may be provided back to the enterprise resource planning system 110 for presentation to a user via the application user interface(s) 104. If one or more duplicates are identified by the duplicate check (e.g., and if a user requests to perform a merge operation of newly-entered data with an identified duplicate data record), the merge handler 116 may coordinate with the cloud-based platform to provide both the newly-entered data and the data of the identified duplicate data record to a generative AI large language model (LLM) API 132 configured to coordinate calls with a generative AI LLM in the generative AI services 134. For example, the LLM may be a machine learning model trained on a vast amount of text data, designed to generate human-like text based on the input it is given. In some cases, an LLM takes a sequence of tokens representing input text, and iteratively predicts additional tokens representing output text. The training for the LLM may be supervised (e.g., using data labeled by a human), semi-supervised (e.g., using a combination of data labeled by a human and unlabeled data), self-supervised (e.g., using unlabeled data that is then labeled by the machine learning model itself from input data for the training, for example, by defining a preliminary task that the model is to solve), and/or unsupervised (e.g., using unlabeled data). The calls may be performed to utilize the generative AI LLM to effect a merging of the newly-entered data with source data (e.g., the existing data record), for example, by filling blank fields in the existing data record with information in corresponding fields of the newly-entered data. Examples of merging data records are described below with respect to FIGS. 2 and 4. Although an LLM is shown in some illustrative examples, it is to be understood that additional or alternative examples may utilize any suitable language model (e.g., instead of or in coordination with an LLM in the described examples), such as other transformer-based language models, neural language models, machine learning-based language models, natural language processing models, and/or similar models.

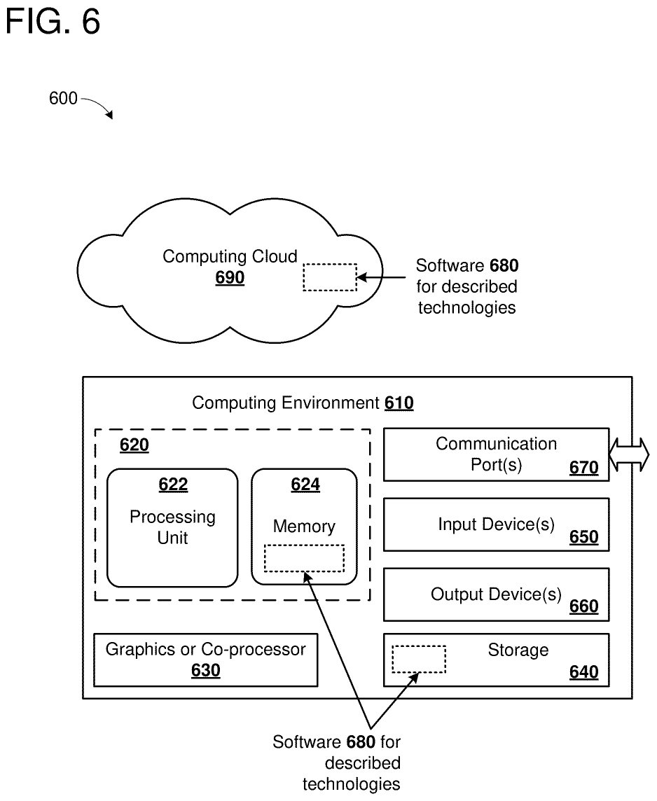

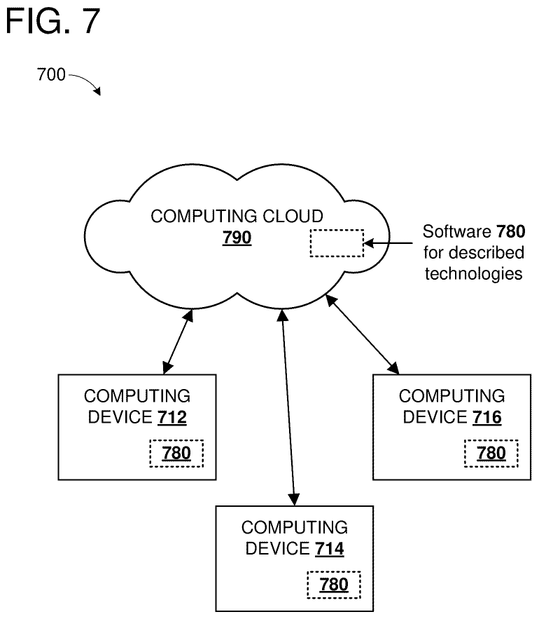

The components of FIG. 1, including the application user interface 104, the enterprise resource planning system 110, cloud-based platform 120, and/or the components included therein may include and/or be implemented in accordance with one or more computing systems or environments, examples of which are described in more detail below with respect to FIGS. 6 and 7.

### Example Method—Using Embeddings to Identify and Merge Duplicate Data Entries

FIG. 2 is a flowchart of an example method 200 for managing database entries in accordance with one or more examples of the present disclosure. For example, method 200 may be performed by one or more components of a system, such as a system 100 of FIG. 1. In some examples, method 200 may be performed by executing instructions of an application user interface or enterprise resource planning system and/or other components described above with respect to FIG. 1.

At 202, the method includes receiving user input including new data and/or entities. For example, a user may input a new data record or information to be stored as a new data record in one or more databases. The data may be entered as one or more strings, as input to one or more defined fields of a graphical user interface (e.g., examples of which are shown in FIGS. 3 and 4 and described in more detail below), and/or in any other suitable format for updating the database(s) to store the input information.

At 204, the method includes converting the user input to word embeddings, or vectors. As described above, embeddings may include numerical or other defined representations of real-world objects or data that machine learning and artificial intelligence (AI) systems use to understand complex knowledge domains in a cognitive manner. Embeddings may convert real-world objects into complex mathematical representations that capture inherent properties and relationships between real-world data. For example, machine learning models are typically unable to interpret information intelligibly in a raw format and instead utilize numerical data as input. Accordingly, machine learning models may use neural network embeddings to convert real-word information into numerical representations referred to herein as vectors. Vectors may include numerical values that represent information in a multi-dimensional space. Vectors may help machine learning models to find similarities among sparsely distributed items. AI systems may self-create embeddings during training and use them as needed to complete new tasks.

For example, the data in the database(s) may be considered to be a master data entity that is converted or transformed to vectors using word embeddings. The same conversion algorithms may be used to convert newly-entered data to vectors in order to allow for comparison between the newly-entered data and the existing data in the database. The conversion may be performed by an AI service, such as generative AI intelligence services 134 of FIG. 1 as a result of one or more API calls from an AI API, such as AI API 128 of FIG. 1 (e.g., which may be triggered by a vector service of a cloud-based computing platform, such as vector service 122 of FIG. 1). In other examples, the conversion may be performed by the vector service.

At 206, the method includes comparing the converted vectors to stored vectors for other data and/or entities in a vector database (e.g., corresponding to a master data entity in the database(s)) to identify duplicates. As indicated at 208, the method may include utilizing one or more cosine similarity functions to check the relatedness of the newly-entered vectors relative to the existing vectors. As further indicated at 210, the method may include utilizing one or more L2 distance functions to find a distance between the newly-entered vectors and the existing vectors. Examples of cosine similarity functions and L2 distance functions are described in more detail below with respect to FIG. 3. Newly-entered vectors that are above a first threshold in similarity and/or below a second threshold in distance (or above a threshold in closeness) may be determined to be duplicates or duplicate candidates. In some examples, different thresholds may be used to identify different levels of similarity/closeness (e.g., different probabilities of being duplicate data). The cosine similarity functions and/or L2 distance functions may be performed by the vector service and/or a cloud service of the cloud-based platform described above.

At 212, the method includes passing any identified duplicates (e.g., duplicate candidates) to a large language model. For example, as described above with respect to FIG. 1, a large language model may be configured to identify duplicate data and/or determine relationships between newly-entered data and fields of the duplicate data based on a context of the data (e.g., to identify duplications even when the data is not a one-to-one exact string or data record match). As further noted with respect to FIG. 1, it is to be understood that in other examples, other types of models may be used to determine the duplicate data and/or relationships in data.

At 214, the method includes updating the source database by merging the identified duplicates with source data in the source database and by adding non-duplicate data (e.g., for a corresponding data record) to the source database. For example, the duplication identification at 206 may identify that the entered data is a duplicate of an existing data record, but has additional information that is not present in the existing data record (e.g., information for fields of the data record that are currently blank in the existing data record). Accordingly, the existing data record may be updated to include the new information in addition to the existing information by merging the new data with the existing data, as described in more detail with respect to FIG. 4. In some examples, an indication of the merged data may be presented to a user via a graphical user interface, as described in more detail below with respect to FIGS. 3 and 4.

### Example User Interface—Data Entry and Database Management Interface

FIG. 3 shows example portions of user interfaces for entering new data and performing a duplicate check. FIG. 4 shows example portions of user interfaces showing an existing data record, a newly entered data record, and a result of merging the newly entered data record with the existing data record. User interfaces 300 and 400a-400c shown in FIGS. 3 and 4, respectively may be examples of one or more application user interfaces, such as application user interface 104 of FIG. 1, which coordinate with an application server or other computing system, such as enterprise resource planning system 110 of FIG. 1 to manage data stored in a backend database, such as data storage 118 of FIG. 1. It is to be understood that the appearance of the user interfaces in FIGS. 3 and 4 are illustrative and non-limiting, and any suitable user interface appearance, views, mechanisms (e.g., user interface elements, user input device, support, etc.), and/or content may be employed to provide the functionality described herein relating to managing data records.

FIG. 3 shows an example user interface 300 for creating a new data entry (e.g., a new data record to be stored in one or more databases). The user interface 300 may include various fields for inputting information relating to the data record. As an illustrative example, the data record may relate to a business partner, entity, individual, and/or other subject, and the fields may include fields relating to name, contact information (e.g., email address, phone number, address), roles at an organization or other hierarchical indications or groupings to which the subject belongs, and/or other data relating to the subject. After entering the desired information for the new data entry, a duplicate check may be performed against existing data in the database by selecting a corresponding user interface element, such as duplicate check button 302.

Selection of the duplicate check button 302 may trigger a duplicate check operation to be performed to identify existing records that may be a duplicate of the new data entry. For example, one or more operations of method 200 may be performed to identify existing data records that are likely to be duplicates of the new data entry based on vectors representing the new and existing data. As shown, a results window 304 may be presented during or after completion of the duplicate check to identify candidate duplicate records for the new data entry. For example, the results window 304 may identify information of the candidate duplicate records (e.g., a record number) and a similarity indication 306 presenting a similarity based on the duplicate check (e.g., shown in the illustrated example as a percentage or likelihood that the record is a duplicate of the new data entry). In some examples, the similarity indication may be a percentage likelihood of being a duplicate (e.g., a match between the new data entry and the corresponding existing data record), based on performance of one or more functions (e.g., similarity and distance, as described above with respect to FIG. 2) on vectors representing the new data entry and the existing data records. For example, a similarity measure may correspond to a mathematical function that maps two vectors to a single number. Popular similarity measures are the L2 distance, which describes the distance of the vectors in Euclidean space, and Cosine Similarity describing the similarity in vector direction. For two vectors u and v, the L2 distance may be defined as:

$${S}_{L 2} ( u , v ) = ‖ v - u ‖ = \sqrt{{\sum }_{i = 1}^{n} {( {v}_{i} - {u}_{i} )}^{2}}$$

and the cosine similarity (e.g., a cosine of an angle between two given feature vectors, indicating how similar the vectors are to one another) may be mathematically defined as:

$${S}_{C} ( u , v ) = \frac{u \cdot v}{‖ u ‖ ‖ v ‖} = \frac{{\sum }_{i = 1}^{n} {u}_{i} {v}_{i}}{\sqrt{{\sum }_{i = 1}^{n} {u}_{i}^{2} \cdot {\sum }_{i = 1}^{n} {v}_{i}^{2}}} .$$

The similarity measures may take two vectors as function arguments (e.g., inputs) and return (e.g., output) a single number. In some examples, the output of the similarity measure(s) may be a number between 0 and 1 (e.g., for L2 distance calculations) or −1 and 1 (e.g., for Cosine Similarity calculations), which is multiplied by 100 to result in a percentage likelihood of being a duplicate. For example, two vectors may be considered to be identical when the cosine of the angle between them is one, and two vectors may be considered to be orthogonal when the cosine of the angle between them is zero. Thus, a cosine value that is closer to 1 (one) indicates that two vectors are more similar, and a cosine value that is closer to 0 (zero) indicates that two vectors are more dissimilar. In additional or alternative examples, outputs of different similarity measurements (e.g., an L2 distance, a Cosine Similarity, and/or any other suitable similarity measurement) may be aggregated (e.g., an average, weighted average, or other aggregation of the results of the similarity measurements may be determined) and converted to a percentage likelihood of being a duplicate (e.g., by multiplying the result of the aggregation by 100).

In some examples, only records with a percentage likelihood of a duplicate that is above a targeted threshold may be shown in the results window. In additional or alternative examples, an additional visual indicator of different tiers of likelihood of duplicates may be shown—for example, a color of the percentage indicator may be selected based on the value of the percentage (e.g., percentages in a first range are shown in a first color, percentages in a second range are shown in a second color, etc., or the percentages are assigned a color along a gradient).

The results window 304 may also include selectable user interface elements 308 for opening a respective candidate duplicate record, allowing the user to view the data in the candidate duplicate record (e.g., and confirm whether it is a duplicate record). In some examples, opening the candidate duplicate record may include presenting a visual copy of the candidate duplicate record as stored and/or annotated or modified to indicate information relating to its status as a duplicate candidate. For example, annotating or modifying the candidate duplicate record may include highlighting fields that are similar to the new data entry in a first manner, highlighting fields that are dissimilar to the new data entry in a second manner, highlighting empty fields in the candidate duplicate record that correspond to fields with data in the new data entry in a third manner, etc., where one or more of the first, second, and third manner of highlighting may differ from one another in some aspect(s) and wherein manners of highlighting may include outlining fields/data, applying semi-transparent color/highlighting over the fields/data, bolding the fields/data, changing a font of text associated with the fields/data, enlarging the fields/data, and/or any other suitable visual alteration of the data record. The results window may also provide an indication of which candidate duplicate records are recommended for merging (e.g., shown by a checkmark 309). The recommendations may be based on a comparison of the similarity to a threshold in some examples.

The results window 304 may also include one or more selectable user interface elements 310 for selecting a corresponding data record for merging with the new data entry. For example, a user may select one or more of the candidate duplicate records via the user interface elements 310 and then select a merge button 312 (e.g., another user interface element) to trigger the system to perform a merge operation to merge the data record of the new data entry with the selected data record(s). The merging may include performing operations such as those described at 212-214 of FIG. 2.

An example outcome of merging duplicate data records is shown in FIG. 4. For example, FIG. 4 shows a portion of a user interface 400a showing a portion of an original data record, a portion of a user interface 400b showing a portion of a new data record (e.g., newly entered, such as via a new data entry user interface as shown in FIG. 3), and a portion of a user interface 400c showing a merged data record resulting from merging the original data record with the new data record. In the illustrated example, the new record may be determined to be a duplicate of the original record (e.g., the original record may be determined to be a candidate duplicate record) after converting the data of the new record (e.g., the first name being “John,” the last name being “Doe,” etc.) to vectors using word embeddings and comparing the vectors to the vectors associated with the original record. The use of embeddings and large language models (or other language models) may contribute to the ability of the system to understand that the country designations of “US” and “USA” are highly similar, despite not being exactly the same, since both abbreviations are commonly used to describe the United States of America. As also shown in the illustrative example of FIG. 4, the new record provides an email address, which is not present in the original record. Accordingly, after merging, the original record is populated with the email address from the new record. The country designation in the merged record remains the same as the original record, as fields deemed similar but different may default to maintaining the data from the original record. In some examples, such fields deemed similar but different may be presented to a user to confirm which data is preferred for the merged record. Furthermore, in some examples, the resulting merged data record may be drafted and shown to the user in a graphical user interface to allow the user to accept or edit the merged data record, and, once confirmed by the user, the original data record may overwritten with the merged data record.

### Example Communications—Operation Calls to Perform Duplicate Checks and Merges

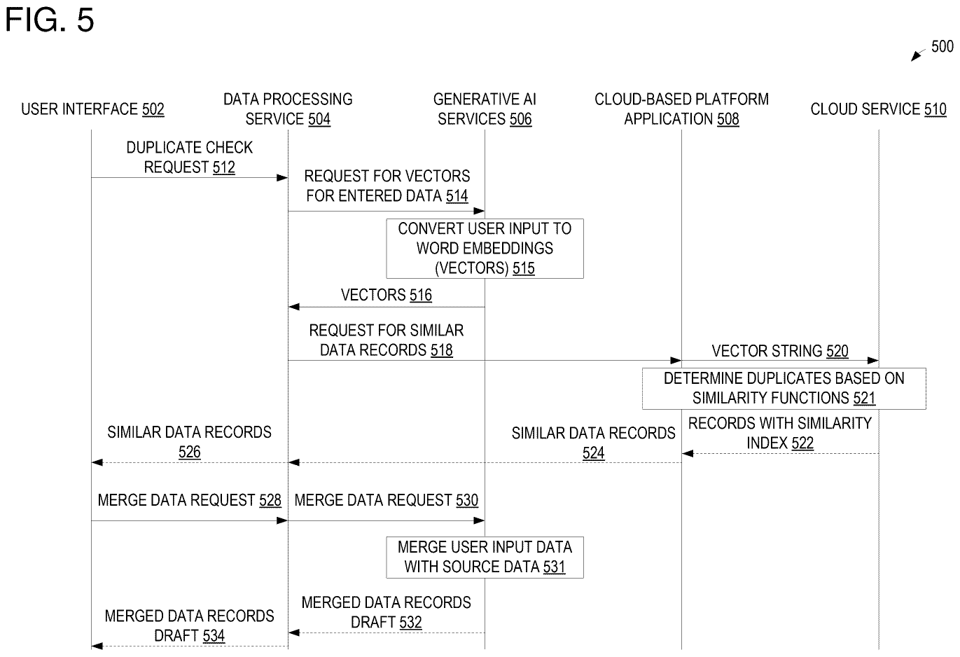

FIG. 5 is a communication diagram 500 of example operations and calls/data communications between components of a database management system to perform duplicate checks and data merging. For example, the communications shown in diagram 500 may be sent between components including a user interface 502, data processing service 504, generative artificial intelligence services 506, cloud-based platform application 508, and cloud service 510. In some examples, the components shown in diagram 500 may be included in and/or may be examples of components of system 100 of FIG. 1. For example, the user interface 502 may be an example of application user interface(s) 104 of FIG. 1, and may be configured to accept user input to control interactions of a user input with components in the database management system. Data processing service 504 may be an example of the enterprise resource planning system 110 and/or a component within and/or in communication with enterprise resource planning system 110 of FIG. 1. For example, data processing service 504 may be configured to process input from the user interface 502 and coordinate with other components of the database management system to execute associated operations based on the user input. Generative artificial intelligence services 506 may be an example of generative artificial intelligence (AI) services 134 of FIG. 1, which may be reachable using one or more A Pls via data processing service 504 and/or cloud-based platform application 508 to perform generative AI processing to facilitate duplicate identification and data record merging as described herein. Cloud-based platform application 508 may be an example of cloud-based platform 120 of FIG. 1 and/or applications included therein or associated therewith. The cloud-based platform application may interface with cloud service 510, which may be an example of cloud service 126 of FIG. 1. In some examples, operations and/or calls shown in diagram 500 may be performed by executing instructions stored in and/or associated with the components shown in diagram 500.

At 512, a duplicate check request is transmitted from the user interface 502 to the data processing service 504. For example, a user may enter data for a new data entry/record and then select to perform a duplicate check (e.g., by selecting a user interface button as shown and described above with respect to FIG. 3). In other examples, the duplicate check request 512 may be sent automatically based on a trigger, such as the detection of newly-entered data.

At 514, the data processing service sends a request to the generative AI services 506 for vectors for entered data (e.g., data entered as part of a new data entry). As described above, the generative AI services 506 may determine the vectors by converting the user input (e.g., the newly-entered data) to word embeddings (or to vectors using word embeddings) that assign a quantitative value to the entered data to enable further processing. At 516, the generative AI services 506 return the determined vectors to the data processing service 504. A s described above with respect to FIG. 1, the data processing service 504 may send the request and receive the vectors using an API to call the generative AI services 506.

At 518, the data processing service 504 sends a request to the cloud-based platform application 508 to determine similar data records (e.g., data records that are similar to the newly-entered data). The request may include the vectors determined by the generative AI services 506, and a corresponding vector string is sent from the cloud-based platform application 508 to the cloud service 510 at 520. For example, the cloud service 510 may include instructions executable to apply one or more functions to determine a similarity between the newly-entered data and existing data records, for example by comparing the vectors for the newly-entered data to stored vectors for the existing data records. Accordingly, at 521, the cloud service 510 (and/or the cloud service 510 in coordination with the cloud-based platform application 508) may determine duplicates based on the similarity functions. At 522, an indication of duplicate data records (or candidate duplicate data records, as described above) and associated similarity indices for the duplicate data records is sent from the cloud service 510 to the cloud-based platform application 508, and the similar/duplicate data records are then forwarded to the data processing service 504 at 524. At 526, the similar/duplicate data records are forwarded from the data processing service 504 to the user interface 502 for presentation to the user, for example, as described above with respect to the results window 304 of FIG. 3.

At 528, the user interface 502 sends a merge data request to the data processing service 504, which forwards the request to the generative AI services 506, as indicated at 530. For example, the merge data request may be sent at 528 responsive to selection of a user interface element to perform a merge, as described with respect to merge button 312 of FIG. 3. In other examples, the merge data request may be automatically sent to the generative AI services 506 based on a trigger, such as a determination of duplicate records with a similarity index (or one or more similarity indices) above a respective threshold. The merge data request may specify a selected one or more duplicate data records into which the newly entered data is to be merged.

At 531, the generative AI services 506 perform a merge operation, merging the newly-entered user input data (e.g., on which the duplicate check request at 512 was performed) with source data (e.g., existing data records in the database). For example, the merge may be performed as described above at 214 of FIG. 2 and/or as described with respect to FIG. 4. A merged data records draft (e.g., a draft of a merged data record based on merging the new data into the existing duplicate data record) may be sent to the data processing service 504 at 532, and forwarded to the user interface 502 at 534 to present the merged data records draft to the user (e.g., for confirmation before saving the merged data record over the existing data record).

### Example Advantages

This solution is superior in comparison of approaches in the past with regards to at least the following considerations. The disclosed approach enables duplicates in data records to be identified without creating or maintaining additional full-text, fuzzy, or other indexes, thereby increasing scalability of the system and decreasing resource load (e.g., enhancing performance of the duplicate checks). For example, in other approaches, the above-described indexes may require continuous manual adjustment or updating to handle new types of data being input into the system, and may be less accurate in identifying duplicates due to a lack of comprehension of a context of the data. The disclosed approach leverages the ability of generative AI services to identify relationships between data and assign a corresponding quantitative value (e.g., a vector) to data that is less cumbersome to store and process when looking for duplicates. Utilizing similarity functions as described herein to analyze the vectors may utilize fewer computing resources than attempting to identify duplicates by engaging one or more of the manually-updated indexes described above. Furthermore, token separators, which are typically necessary in terms of full-text indexes, can sometimes split tokens at unintended points. For example, a hyphen may be interpreted as a token separator in texts containing dimensions or identifiers like “RPDB-1Y-1” or “UDB-1R-2.” With semantic search using vectors and similarity/distance functions as described for the disclosed approaches, these cases can be avoided, ensuring more accurate results.

As a further example, the limitations of fuzzy search arise when using “non-whitespace” languages, such as Chinese and Japanese, that do not use space characters to separate words. One significant limitation is substring search. Substring search relies on word boundaries to locate results and calculate scores. However, in “non-whitespace” languages, where words are not separated by spaces, substring search cannot accurately determine word boundaries. As a workaround, users can manually insert space characters between words when entering search terms. However, this approach compromises the accuracy of scores because the word boundaries in the database entries are unknown. To overcome these limitations, the use of embeddings in the disclosed approaches, which have the ability to understand semantics, can provide a more accurate and efficient solution to identifying duplicates in database entries. Likewise, a setup cost to merge duplicates may be reduced by leveraging a large language model or other language model as described above for the disclosed approaches. Furthermore, by merging data records as described herein based on the duplicate checking, data storage space may be conserved by reducing the presence of redundant data in the database.

### ADDITIONAL EXAMPLES

A first example of the disclosed technologies includes a computer-implemented method comprising: receiving user input including newly-entered data for a new data record, converting the newly-entered data into one or more vectors using word embeddings, comparing the converted vectors to stored vectors for one or more existing data records in a database using one or more functions configured to indicate a likelihood of a match between the newly-entered data and one or more of the existing data records, identifying a duplicate data record in the database, wherein the indicated likelihood of a match between the newly-entered data and the duplicate data record is above a threshold, inputting the newly-entered data and the duplicate data record into a language model (e.g., a large language model) to determine relationships between the newly-entered data and fields of the duplicate data record, generating a merged data record by merging the newly-entered data with the duplicate data record based on the determined relationships between the newly-entered data and fields of the duplicate data record, and storing the merged data record in the database.

A second example of the disclosed technologies includes the first example, and further includes the method, wherein the merged data record is stored in the database by overwriting the duplicate data record with the merged data record.

A third example of the disclosed technologies includes the first example and/or the second example, and further includes the method, wherein the one or more functions includes a cosine similarity function configured to check a relatedness of the converted vectors to the stored vectors.

A fourth example of the disclosed technologies includes one or more of the first through third examples, and further includes the method, wherein the one or more functions includes an L2 distance function configured to determine a distance between the converted vectors and the stored vectors.

A fifth example of the disclosed technologies includes one or more of the first through fourth examples, and further includes the method, wherein the duplicate data record is a first candidate duplicate data record identified by comparing the converted vectors to the stored vectors, and wherein one or more additional candidate duplicate data records are also identified by comparing the converted vectors to the stored vectors.

A sixth example of the disclosed technologies includes one or more of the first through fifth examples, and further includes the method, further comprising presenting, via a user interface, a respective identification and similarity index of each of the first candidate duplicate data record and the one or more additional candidate duplicate data records to a user, wherein the similarity index comprises an indication of the likelihood of a match between the newly-entered data and one or more of the existing data records determined based on the one or more functions.

A seventh example of the disclosed technologies includes one or more of the first through sixth examples, and further includes the method, wherein the merged data record is generated responsive to a selection of the first candidate duplicate data record and a request to merge the new data record with the first candidate duplicate data record received via the user interface.

An eighth example of the disclosed technologies includes one or more of the first through seventh examples, and further comprises the method, wherein the user input is received via the user interface.

A ninth example of the disclosed technologies includes one or more of the first through eighth examples, and further comprises the method, wherein the newly-entered data is converted into the one or more vectors using an Application Programming Interface (API) call to an external generative artificial intelligence service.

A tenth example of the disclosed technologies includes one or more of the first through ninth examples, and further comprises the method, wherein the language model is a large language model, and wherein newly-entered data and the duplicate data record are input into the large language model using an Application Programming Interface (API) call to an external generative artificial intelligence service.

An eleventh example of the disclosed technologies includes a computing system comprising at least one hardware processor, at least one memory coupled to the at least one hardware processor, a database comprising a plurality of existing data records, and one or more non-transitory computer-readable media having stored therein computer-executable instructions that, when executed by the computing system, cause the computing system to: receive newly-entered data for a new data record from an application user interface, convert the newly-entered data into one or more vectors using word embeddings, compare the converted vectors to stored vectors for the plurality of existing data records in the database using one or more functions configured to indicate a likelihood of a match between the newly-entered data and respective data records of the plurality of existing data records, identify, among the plurality of existing data records, a duplicate data record, wherein the indicated likelihood of a match between the newly-entered data and the duplicate data record is above a threshold, input the newly-entered data and the duplicate data record into a language model to determine relationships between the newly-entered data and fields of the duplicate data record, generate a merged data record by merging the newly-entered data with the duplicate data record based on the determined relationships between the newly-entered data and fields of the duplicate data record, and store the merged data record in the database.

A twelfth example of the disclosed technologies includes the eleventh example and further includes the computing system, wherein the newly-entered data is converted into the one or more vectors by utilizing an Application Programming Interface (API) of a cloud-based platform, the API configured to communicate with a generative artificial intelligence (AI) service to cause the generative AI service to perform the conversion of the newly-entered data into the one or more vectors.

A thirteenth example of the disclosed technologies includes the eleventh and/or the twelfth examples, and further includes the computing system, wherein the converted vectors are compared to the stored vectors for the plurality of existing data records in the database by requesting a cloud service of a cloud-based platform to apply the one or more functions to the converted vectors and the stored vectors.

A fourteenth example of the disclosed technologies includes one or more of the eleventh through the thirteenth examples, and further includes the computing system, wherein the newly-entered data and the duplicate data record are input into the language model by utilizing an Application Programming Interface (API) of a cloud-based platform, the API further configured to communicate with a generative artificial intelligence (AI) service to cause the generative AI service to determine the relationships between the newly-entered data and fields of the duplicate data record.

A fifteenth example of the disclosed technologies includes one or more of the eleventh through the fourteenth examples, and further includes the computing system, wherein the stored vectors for the plurality of existing data records are stored in a vector database.

A sixteenth example of the disclosed technologies includes one or more of the eleventh through the fifteenth examples, and further includes the computing system, wherein the vector database is included in a cloud-based platform in communication with the computing system.

A seventeenth example of the disclosed technologies includes one or more of the eleventh through the sixteenth examples, and further includes the computing system, wherein the one or more functions includes one or more of a cosine similarity function configured to check a relatedness of the converted vectors to the stored vectors or an L2 distance function configured to determine a distance between the converted vectors and the stored vectors.

An eighteenth example of the disclosed technologies includes one or more non-transitory computer-readable media comprising computer-executable instructions that, when executed by a computing system, cause the computing system to perform operations comprising: receiving newly-entered data for a new data record from an application user interface, converting the newly-entered data into one or more vectors using word embeddings, comparing the converted vectors to stored vectors for the plurality of existing data records in the database using one or more functions configured to indicate a likelihood of a match between the newly-entered data and respective data records of the plurality of existing data records, identifying, among the plurality of existing data records, a duplicate data record, wherein the indicated likelihood of a match between the newly-entered data and the duplicate data record is above a threshold, inputting the newly-entered data and the duplicate data record into a language model to determine relationships between the newly-entered data and fields of the duplicate data record, generating a merged data record by merging the newly-entered data with the duplicate data record based on the determined relationships between the newly-entered data and fields of the duplicate data record, and storing the merged data record in the database.

A nineteenth example of the disclosed technologies includes the eighteenth example, and further includes the one or more non-transitory computer-readable media, wherein the one or more functions includes one or more of a cosine similarity function configured to check a relatedness of the converted vectors to the stored vectors or an L2 distance function configured to determine a distance between the converted vectors and the stored vectors.

A twentieth example of the disclosed technologies includes the eighteenth example and/or the nineteenth example, and further includes the one or more non-transitory computer-readable media, wherein the newly-entered data is converted into the one or more vectors using a first Application Programming Interface (API) call to one or more external generative artificial intelligence services and wherein the newly-entered data and the duplicate data record are input into a language model using a second API call to the one or more external generative artificial intelligence services.

### A Generalized Computer Environment

FIG. 6 illustrates a generalized example of a suitable computing system 600 in which described examples, techniques, and technologies, including entering new data and performing duplicate checks and merging with existing data records according to disclosed technologies can be implemented. For example, the computing system 600 and/or one or more elements of the computing system 600 may include and/or be included within one or more of the described components of system 100 of FIG. 1 and/or FIG. 5, and/or be used to perform operations described in correspondence to FIGS. 2-5. The computing system 600 is not intended to suggest any limitation as to scope of use or functionality of the present disclosure, as the innovations can be implemented in diverse general-purpose or special-purpose computing systems.

With reference to FIG. 6, computing environment 610 includes one or more processing units 622 and memory 624. In FIG. 6, this basic configuration 620 is included within a dashed line. Processing unit 622 executes computer-executable instructions, such as for implementing any of the methods or objects described herein for performing annotation word-to-token alignment, or various other architectures, components, handlers, managers, modules, or services described herein. Processing unit 622 can be a general-purpose central processing unit (CPU), a processor in an application-specific integrated circuit (ASIC), or any other type of processor. In a multi-processing system, multiple processing units execute computer-executable instructions to increase processing power. Computing environment 610 can also include a graphics processing unit or co-processing unit 630. Tangible memory 624 can be volatile memory (e.g., registers, cache, or RAM), non-volatile memory (e.g., ROM, EEPROM, or flash memory), or some combination thereof, accessible by processing units 622, 630. The memory 624 stores software 680 implementing one or more innovations described herein, in the form of computer-executable instructions suitable for execution by the processing unit(s) 622, 630. The memory 624 can also store footprint calculation data, a composite graph data structure, including nodes, edges, and their respective attributes; a table or other data structure indicating states of a modeled system, configuration data, User Interface (UI) displays, browser code, data structures including data tables, working tables, change logs, output structures, input fields, output fields, data values, indices, or flags, as well as other operational data.

A computing system 610 can have additional features, such as one or more of storage 640, input devices 650, output devices 660, or communication ports 670. An interconnection mechanism (not shown) such as a bus, controller, or network interconnects the components of the computing environment 610. Typically, operating system software (not shown) provides an operating environment for other software executing in the computing environment 610, and coordinates activities of the components of the computing environment 610.

The tangible storage 640 can be removable or non-removable, and includes magnetic disks, magnetic tapes or cassettes, CD-ROMs, DVDs, or any other medium which can be used to store information in a non-transitory way and which can be accessed within the computing environment 610. The storage 640 stores instructions of the software 680 (including instructions and/or data) implementing one or more innovations described herein.

The input device(s) 650 can be a mechanical, touch-sensing, or proximity-sensing input device such as a keyboard, mouse, pen, touchscreen, trackball, a voice input device, a scanning device, or another device that provides input to the computing environment 610. The output device(s) 660 can be a display, printer, speaker, optical disk writer, or another device that provides output from the computing environment 610.

The communication port(s) 670 enable communication over a communication medium to another computing device. The communication medium conveys information such as computer-executable instructions or other data in a modulated data signal. A modulated data signal is a signal that has one or more of its characteristics set or changed in such a manner as to encode information in the signal. By way of example, and not limitation, communication media can use an electrical, optical, R F, acoustic, or other carrier.

In some examples, computer system 600 can also include a computing cloud 690 in which instructions implementing all or a portion of the disclosed technology are executed. A ny combination of memory 624, storage 640, and computing cloud 690 can be used to store software instructions and data of the disclosed technologies.

The present innovations can be described in the general context of computer-executable instructions, such as those included in program modules, being executed in a computing system on a target real or virtual processor. Generally, program modules or components include routines, programs, libraries, software objects, classes, components, data structures, etc. that perform tasks or implement particular abstract data types. The functionality of the program modules can be combined or split between program modules as desired in various embodiments. Computer-executable instructions for program modules can be executed within a local or distributed computing system.

The terms “system,” “environment,” and “device” are used interchangeably herein. Unless the context clearly indicates otherwise, none of these terms implies any limitation on a type of computing system, computing environment, or computing device. In general, a computing system, computing environment, or computing device can be local or distributed, and can include any combination of special-purpose hardware and/or general-purpose hardware and/or virtualized hardware, together with software implementing the functionality described herein. Virtual processors, virtual hardware, and virtualized devices are ultimately embodied in a hardware processor or another form of physical computer hardware, and thus include both software associated with virtualization and underlying hardware.

### Example Cloud Computing Environment

FIG. 7 depicts an example cloud computing environment 700 in which the described technologies can be implemented. For example, the computing environment 700 and/or one or more elements of the computing environment 700 may include and/or be included within one or more of the described components of system 100 of FIG. 1 and/or FIG. 5, and/or be used to perform operations (or present user interfaces) described in correspondence to FIGS. 2-5. The cloud computing environment 700 comprises a computing cloud 790 containing resources and providing services. The computing cloud 790 can comprise various types of cloud computing resources, such as computer servers, data storage repositories, networking resources, and so forth. The computing cloud 790 can be centrally located (e.g., provided by a data center of a business or organization) or distributed (e.g., provided by various computing resources located at different locations, such as different data centers and/or located in different cities or countries).

The computing cloud 790 can be operatively connected to various types of computing devices (e.g., client computing devices), such as computing devices 712, 714, and 716, and can provide a range of computing services thereto. One or more of computing devices 712, 714, and 716 can be computers (e.g., servers, virtual machines, embedded systems, desktop, or laptop computers), mobile devices (e.g., tablet computers, smartphones, or wearable appliances), or other types of computing devices. Communication links between computing cloud 790 and computing devices 712, 714, and 716 can be over wired, wireless, or optical links, or any combination thereof, and can be short-lived or long-lasting. Communication links can be continuous or sporadic. These communication links can be stationary or can move over time, being implemented over varying paths and having varying attachment points at each end. Computing devices 712, 714, and 716 can also be connected to each other.

Computing devices 712, 714, and 716 can utilize the computing cloud 790 to obtain computing services and perform computing operations (e.g., data processing, data storage, and the like). Particularly, software 780 for performing the described innovative technologies can be resident or executed in the computing cloud 790, in computing devices 712, 714, and 716, or in a distributed combination of cloud and computing devices.

### General Considerations

As used in this disclosure, the singular forms “a,” “an,” and “the” include the plural forms unless the surrounding language clearly dictates otherwise. Additionally, the terms “includes” and “incorporates” mean “comprises.” Further, the terms “coupled” or “attached” encompass mechanical, electrical, magnetic, optical, as well as other practical ways of coupling items together, and does not exclude the presence of intermediate elements between the coupled items. Furthermore, as used herein, the terms “or” and “and/or” mean any one item or combination of items in the phrase.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media, such as tangible, non-transitory computer-readable storage media, and executed on a computing device (e.g., any available computing device, including tablets, smartphones, or other mobile devices that include computing hardware). Tangible computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example, and with reference to FIG. 6, computer-readable storage media include memory 624, and storage 640. The term computer-readable storage media does not include signals and carrier waves. In addition, the term computer-readable storage media does not include communication ports (e.g., 670) or communication media.

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network, a cloud computing network, or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in ABAP, Adobe Flash, Angular, C, C++, C#, Curl, Dart, Fortran, Go, Java, JavaScript, Julia, Lisp, Matlab, Octave, Perl, Python, R, Ruby, SAS, SPSS, WebAssembly, any derivatives thereof, or any other suitable programming language, or, in some examples, markup languages such as HTML or XML, or in any combination of suitable languages, libraries, and packages. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, infrared, and optical communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub-combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

1. A computer-implemented method comprising:
receiving user input including newly-entered data for a new data record;
converting the newly-entered data into one or more vectors using word embeddings;
comparing the one or more vectors to stored vectors for one or more existing data records in a database using one or more functions configured to indicate a likelihood of a match between the newly-entered data and one or more of the existing data records;
identifying a duplicate data record in the database, wherein the indicated likelihood of a match between the newly-entered data and the duplicate data record is above a threshold;
inputting the newly-entered data and the duplicate data record into a language model to determine relationships between respective data items of the newly-entered data and corresponding fields of the duplicate data record, including identifying at least one field of the duplicate data record to be populated or modified using a corresponding data item of the newly-entered data;
generating a merged data record by merging the newly-entered data with the duplicate data record based on the determined relationships between the newly-entered data and the fields of the duplicate data record; and
storing the merged data record in the database.

2. The computer-implemented method of claim 1, wherein the merged data record is stored in the database by overwriting the duplicate data record with the merged data record.

3. The computer-implemented method of claim 1, wherein the one or more functions includes a cosine similarity function configured to check a relatedness of the one or more vectors to the stored vectors.

4. The computer-implemented method of claim 1, wherein the one or more functions includes an L2 distance function configured to determine a distance between the one or more vectors and the stored vectors.

5. The computer-implemented method of claim 1, wherein the duplicate data record is a first candidate duplicate data record identified by comparing the one or more vectors to the stored vectors, and wherein one or more additional candidate duplicate data records are also identified by comparing the converted vectors to the stored vectors.

6. The computer-implemented method of claim 5, further comprising presenting, via a user interface, a respective identification and similarity index of each of the first candidate duplicate data record and the one or more additional candidate duplicate data records to a user, wherein the similarity index comprises an indication of the likelihood of a match between the newly-entered data and one or more of the existing data records determined based on the one or more functions.

7. The computer-implemented method of claim 6, wherein the user input is received via the user interface, and wherein the merged data record is generated responsive to a selection of the first candidate duplicate data record and a request to merge the new data record with the first candidate duplicate data record received via the user interface.

8. The computer-implemented method of claim 1, wherein identifying the at least one field comprises identifying an empty field of the duplicate data record that corresponds to the corresponding data item of the newly-entered data, and wherein generating the merged data record comprises populating the empty field with the corresponding data item.

9. The computer-implemented method of claim 1, wherein the newly-entered data is converted into the one or more vectors using an Application Programming Interface (API) call to an external generative artificial intelligence service.

10. The computer-implemented method of claim 1, wherein the language model is a large language model, and wherein newly-entered data and the duplicate data record are input into the language model using an Application Programming Interface (API) call to an external generative artificial intelligence service.

11. A computing system comprising:
at least one hardware processor;
at least one memory coupled to the at least one hardware processor;
a database comprising a plurality of existing data records; and
one or more non-transitory computer-readable media having stored therein computer-executable instructions that, when executed by the computing system, cause the computing system to:
receive newly-entered data for a new data record from an application user interface;
convert the newly-entered data into one or more vectors using word embeddings;
compare the one or more vectors to stored vectors for the plurality of existing data records in the database using one or more functions configured to indicate a likelihood of a match between the newly-entered data and respective data records of the plurality of existing data records;
identify, among the plurality of existing data records, a duplicate data record, wherein the indicated likelihood of a match between the newly-entered data and the duplicate data record is above a threshold;
input the newly-entered data and the duplicate data record into a language model to determine relationships between respective data items of the newly-entered data and corresponding fields of the duplicate data record, including identifying at least one field of the duplicate data record to be populated or modified using a corresponding data item of the newly-entered data;
generate a merged data record by merging the newly-entered data with the duplicate data record based on the determined relationships between the newly-entered data and the fields of the duplicate data record; and
store the merged data record in the database.

12. The computing system of claim 11, wherein the newly-entered data is converted into the one or more vectors by utilizing an Application Programming Interface (API) of a cloud-based platform, the API configured to communicate with a generative artificial intelligence (AI) service to cause the generative AI service to perform the converting of the newly-entered data into the one or more vectors.

13. The computing system of claim 11, wherein the one or more vectors are compared to the stored vectors for the plurality of existing data records in the database by requesting a cloud service of a cloud-based platform to apply the one or more functions to the one or more vectors and the stored vectors.

14. The computing system of claim 11, wherein the newly-entered data and the duplicate data record are input into the language model by utilizing an Application Programming Interface (API) of a cloud-based platform, the API further configured to communicate with a generative artificial intelligence (AI) service to cause the generative AI service to determine the relationships between the newly-entered data and the fields of the duplicate data record.

15. The computing system of claim 11, wherein the stored vectors for the plurality of existing data records are stored in a vector database.

16. The computing system of claim 15, wherein the vector database is included in a cloud-based platform in communication with the computing system.

17. The computing system of claim 11, wherein the one or more functions includes one or more of a cosine similarity function configured to check a relatedness of the one or more vectors to the stored vectors or an L2 distance function configured to determine a distance between the one or more vectors and the stored vectors.

18. One or more non-transitory computer-readable media comprising computer-executable instructions that, when executed by a computing system, cause the computing system to perform operations comprising:
receiving newly-entered data for a new data record from an application user interface;
converting the newly-entered data into one or more vectors using word embeddings;
comparing the one or more vectors to stored vectors for a plurality of existing data records in a database using one or more functions configured to indicate a likelihood of a match between the newly-entered data and respective data records of the plurality of existing data records;
identifying, among the plurality of existing data records, a duplicate data record, wherein the indicated likelihood of a match between the newly-entered data and the duplicate data record is above a threshold;
inputting the newly-entered data and the duplicate data record into a language model to determine relationships between respective data items of the newly-entered data and corresponding fields of the duplicate data record, including identifying at least one field of the duplicate data record to be populated or modified using a corresponding data item of the newly-entered data;
generating a merged data record by merging the newly-entered data with the duplicate data record based on the determined relationships between the newly-entered data and fields of the duplicate data record; and
storing the merged data record in the database.

19. The one or more non-transitory computer-readable media of claim 18, wherein the one or more functions includes one or more of a cosine similarity function configured to check a relatedness of the one or more vectors to the stored vectors or an L2 distance function configured to determine a distance between the one or more vectors and the stored vectors.

20. The one or more non-transitory computer-readable media of claim 18, wherein the newly-entered data is converted into the one or more vectors using a first Application Programming Interface (API) call to one or more external generative artificial intelligence services and wherein the newly-entered data and the duplicate data record are input into a language model using a second API call to the one or more external generative artificial intelligence services.
